(19) United States
(12) Patent Application Publication
(10) Pub. No.: US 2022/0043400 A1
(43) Pub. Date: Feb. 10, 2022

(54) TRIGGERING MOBILE APPLICATION USING MOVABLE EXTERNAL DEVICE

(71) Applicant: ZooBean LLC, Wilmington, DE (US)

(72) Inventors: Felix Lloyd, Washington, DC (US); Jordan Bookey, Washington, DC (US)

(21) Appl. No.: 17/232,686

(22) PCT Filed: Oct. 16, 2019
(86) PCT No.: PCT/US2019/056494

§ 371 Date: Apr. 16, 2021

Related U.S. Application Data
(60) Provisional application No. 62/746,033, filed on Oct. 16, 2018.

(51) Int. Cl. G04F 1/04; G04F 1/00; G04B 47/00; G04G 21/00

(52) U.S. Cl. CPC G04F 1/04; G04G 21/00; G04B 47/00; G04F 1/005

(57) ABSTRACT

In one embodiment there is a method for activating a function of a mobile application on a mobile device, using a movable device, the movable device including a processor, the processor including an inertial measurement unit and a wireless transmitter. The method comprising: at the movable device: detecting a movement signal at the inertial measurement unit indicating movement of the movable device; in response to detecting the movement signal from the wireless transmitter, determining whether the movement signal meets movement criteria; in response to determining that the movement signal meets movement criteria, transmitting a function activation signal to the mobile device to activate the function of the mobile application; and in response to determining that the movement signal does not meet movement criteria, refraining from transmitting a function activation signal to the mobile device to activate the function of the mobile application.

### CROSS-REFERENCE TO RELATED APPLICATIONS

This application claims the benefit of U.S. Provisional Patent Application No. 62/746,033 filed Oct. 16, 2018 entitled “Triggering Mobile Application Using Movable External Device”, incorporated by reference herein in its entirety.

### BACKGROUND

For individuals, groups and/or teams seeking to better enhance data surrounding the amount of time a child spends performing activities associated with mobile applications, there are limits on the resources they can use with children to track, access and analyze this data in an effective way and on a consistent basis. For example, there may be a need to track and analyze an amount of time a child spends reading a book. Thus, there is a growing interest in being able to track a child's actions in conjunction with a mobile application.

### SUMMARY

Without limiting the scope of the appended claims, after considering this disclosure, and particularly after considering the section entitled “Detailed Description,” one will understand how the aspects of various embodiments are implemented and used to track elapsed time, for various purposes, with a movable device.

In one embodiment there is a method for activating a function of a mobile application on a mobile device, using a movable device, the movable device may include a processor, an inertial measurement unit and a wireless transmitter. The method may comprise, at the movable device: detecting a movement signal at the inertial measurement unit indicating movement of the movable device. In one embodiment, in response to detecting the movement signal from the wireless transmitter, determining whether the movement signal meets movement criteria. In one embodiment, in response to determining that the movement signal meets movement criteria, transmitting a function activation signal to the mobile device to activate the function of the mobile application. In another embodiment, in response to determining that the movement signal does not meet movement criteria, refraining from transmitting a function activation signal to the mobile device to activate the function of the mobile application.

In some embodiments, the movement criteria includes a criterion that is met when the movable device has rotated 180 degrees along an axis perpendicular to gravity.

In some embodiments, the function of the mobile application is a timer.

In some embodiments, activating the function of the mobile application includes initiating the timer on the mobile application.

In some embodiments, the method further comprising: at the mobile device: in response to receiving the function activation signal, activating the function on the mobile application.

In another embodiment there is a system for activating a function of a mobile application on a mobile device, the system comprising: a movable device, the movable device including a processor, an inertial measurement unit and a wireless transmitter. The processor may be configured to perform the steps of: detecting a movement signal at the inertial measurement unit indicating movement of the movable device. In one embodiment, in response to detecting the movement signal from the wireless transmitter, determining whether the movement signal meets movement criteria. In one embodiment, in response to determining that the movement signal meets movement criteria, transmitting a function activation signal to the mobile device to activate the function of the mobile application. In another embodiment, in response to determining that the movement signal does not meet movement criteria, refraining from transmitting a function activation signal to the mobile device to activate the function of the mobile application.

In some embodiments the movement criteria includes a criterion that is met when the movable device has rotated 180 degrees along an axis perpendicular to gravity.

In some embodiments the function of the mobile application is a timer.

In some embodiments activating the function of the mobile application includes initiating the timer on the mobile application.

In some embodiments the mobile device is configured to perform the steps of, in response to receiving the function activation signal, activating the function on the mobile application.

### BRIEF DESCRIPTION OF THE SEVERAL VIEWS OF THE DRAWINGS

The foregoing summary, as well as the following detailed description of embodiments of the disclosed invention, will be better understood when read in conjunction with the appended drawings of an exemplary embodiment. It should be understood, however, that the invention is not limited to the precise arrangements and instrumentalities shown.

In the drawings:

FIG. 1 is a block diagram illustrating the system for tracking and analyzing user actions, in accordance with some implementations.

FIGS. 2A-2B are a block diagram representation of a movable device to activate one or more functions in a mobile application in accordance with an exemplary embodiment of the present invention;

FIG. 3 is a flow diagram illustrating a method for activating a function of a mobile application on a mobile device, using a movable device, in accordance with some implementations;

FIG. 4 is a top, front, left-side perspective view of an electronic hourglass-shaped device in accordance with our new design;

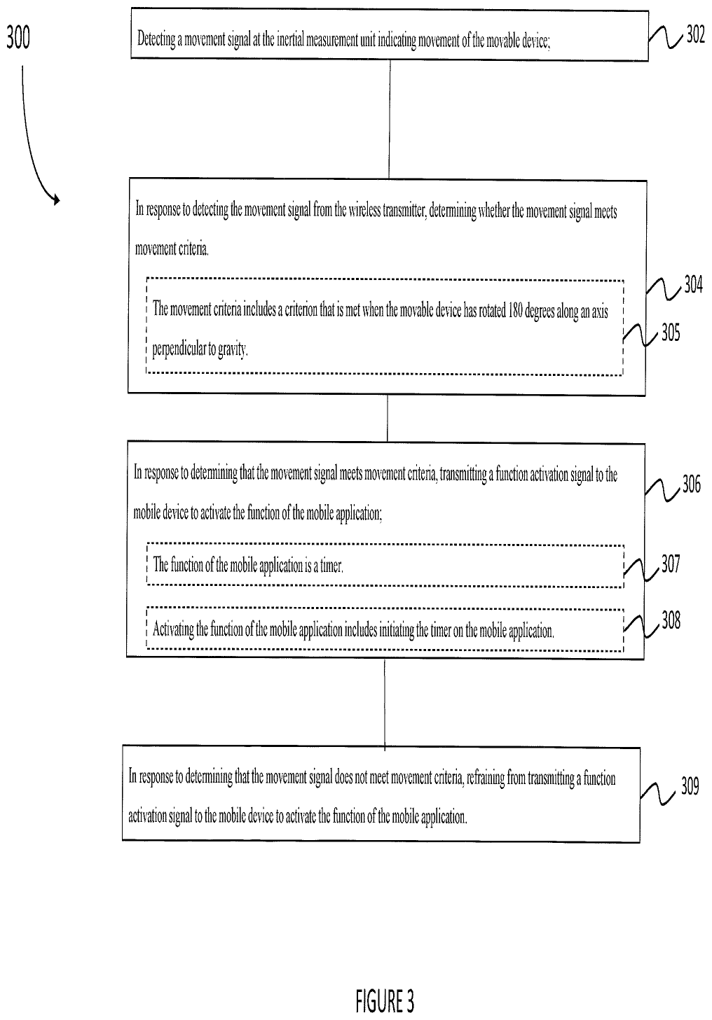

FIG. 5 is a front elevational view of an electronic hourglass-shaped device, in accordance with our new design;

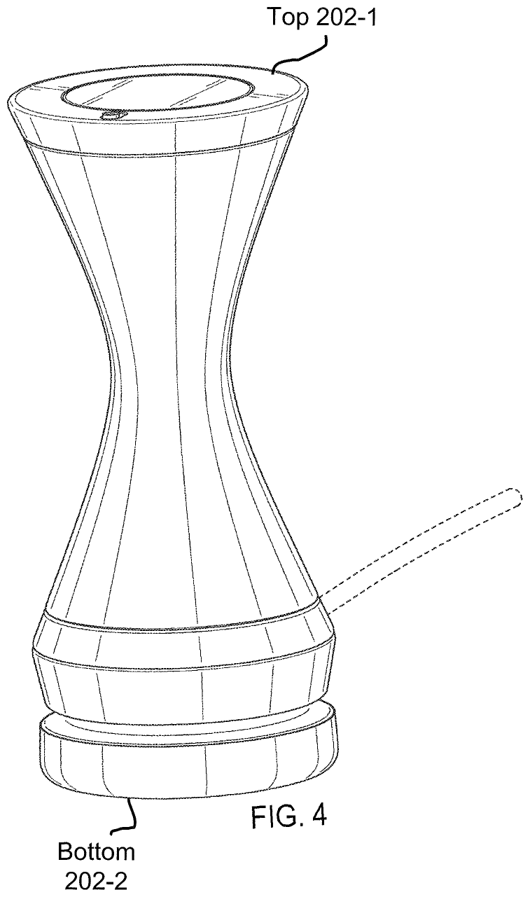

FIG. 6 is a rear elevational view of an electronic hourglass-shaped device, in accordance with our new design;

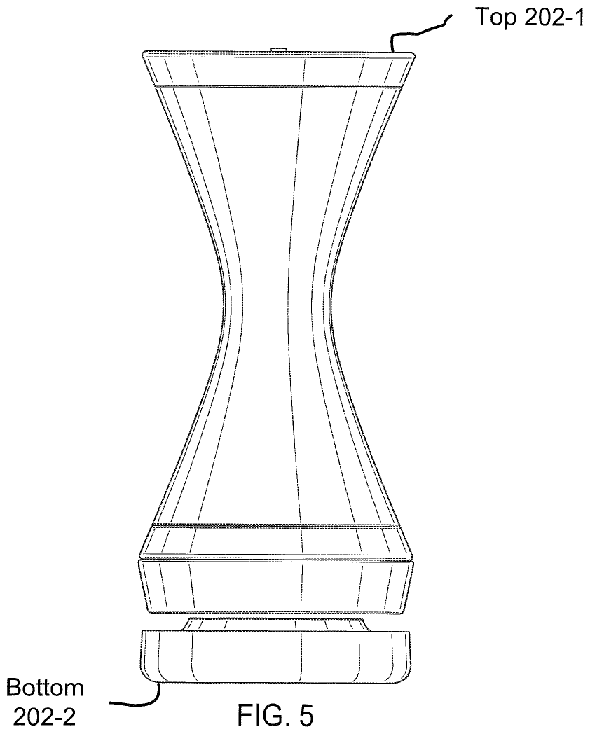

FIG. 7 is a right-side elevational view of an electronic hourglass-shaped device, in accordance with our new design;

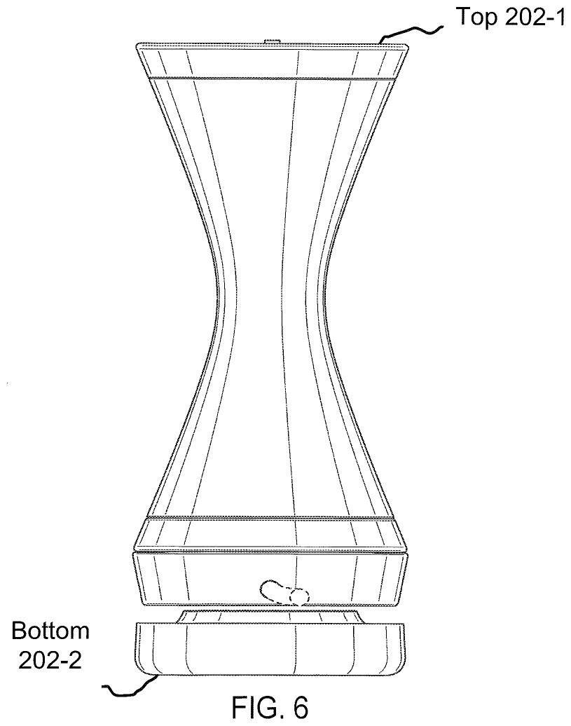

FIG. 8 is a left-side elevational view of an electronic hourglass-shaped device, in accordance with our new design;

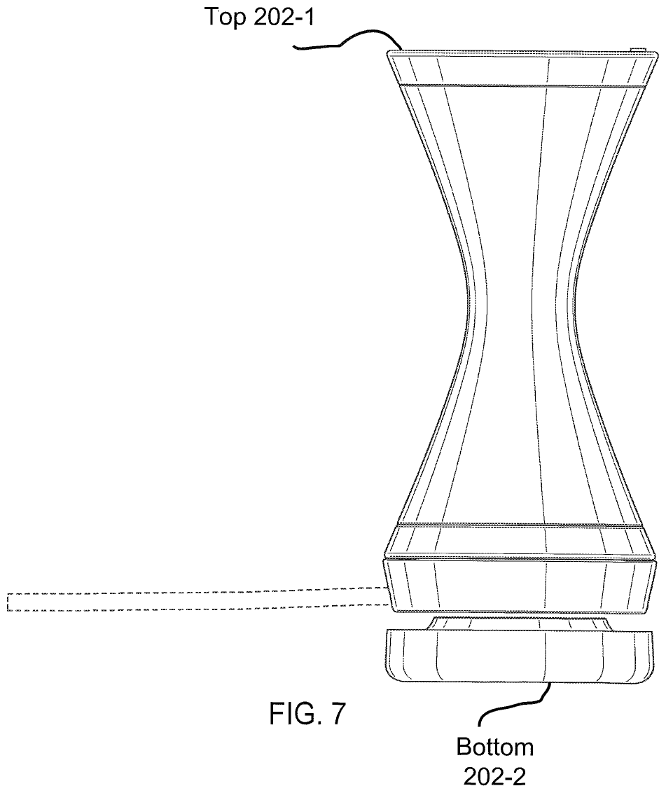

FIG. 9 is a bottom plan view of an electronic hourglass-shaped device, in accordance with our new design; and

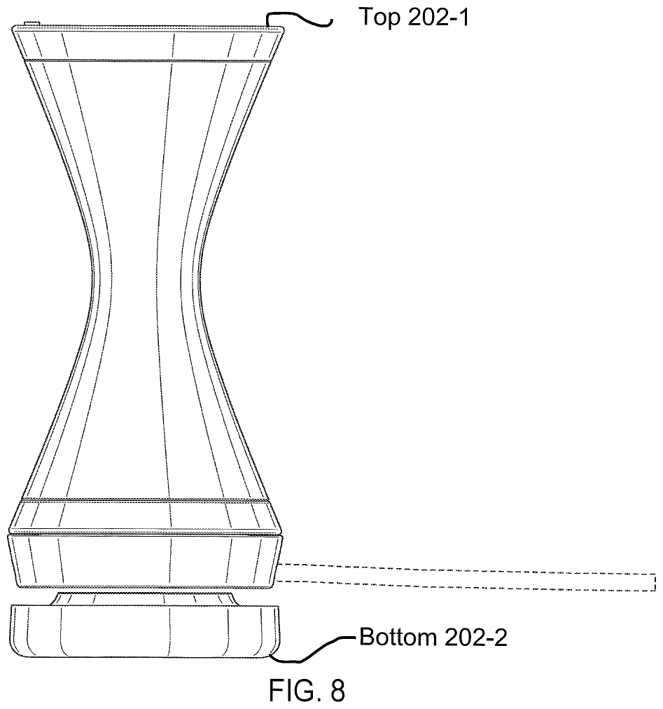

FIG. 10 a top plan view of an electronic hourglass-shaped device, in accordance with our new design.

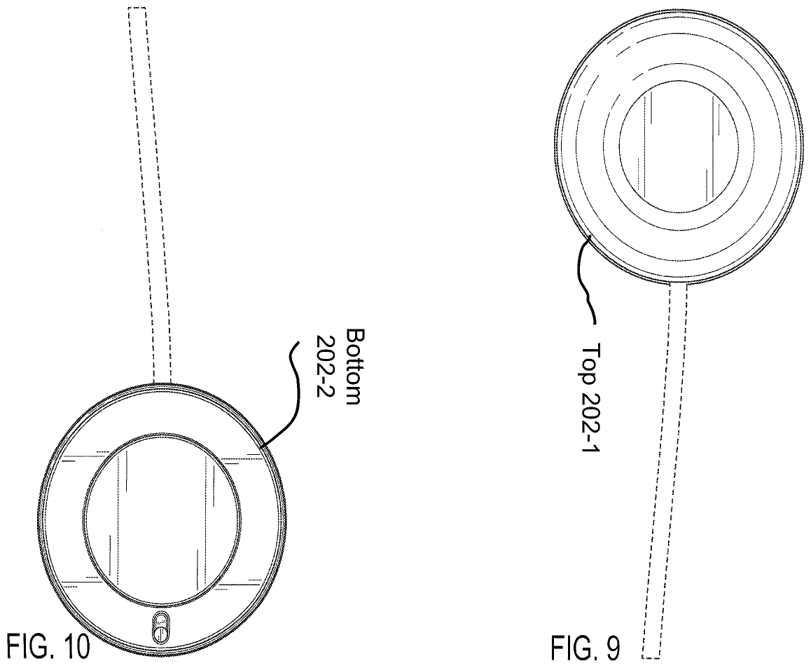

### DETAILED DESCRIPTION

Being unable to efficiently and consistently track and analyze time spent performing an activity, such as reading, for various purposes, is a disadvantage to the user. Consequently, what is desired is a method and system to trigger time-start and time-end based on the movement of an external movable device. For ease of explanation, the activity described herein is directed to reading a book, but other activities may be tracked and analyzed, in accordance with other embodiments of the invention.

Tracking time spent reading a book or a number of different books is useful both over the short-term and long-term. In this regard, it is both easy and helpful for any user, regardless of their age, to flip an hourglass shaped device that would activate a timer. Flipping an hourglass shaped device is much more intuitive to users as opposed to performing a multitude of user-selections on a mobile device to activate a timer in a mobile application.

Numerous details are described herein in order to provide a thorough understanding of the example embodiments illustrated in the accompanying drawings. However, some embodiments may be practiced without many of the specific details, and the scope of the claims is only limited by those features and aspects specifically recited in the claims. Furthermore, well-known methods, components, and circuits have not been described in exhaustive detail so as not to unnecessarily obscure pertinent aspects of the embodiments described herein.

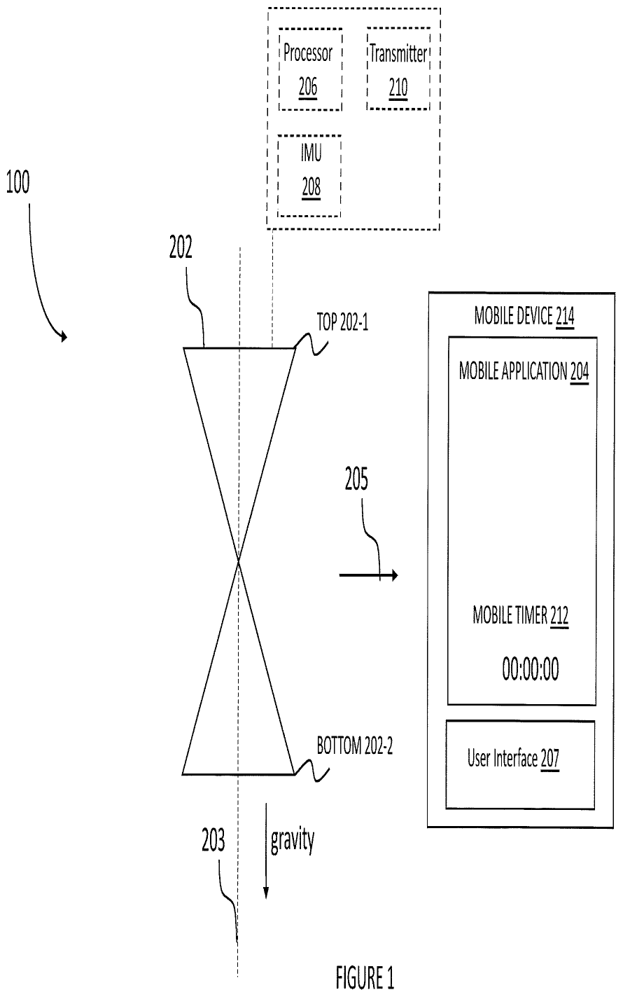

FIG. 1 is a block diagram tracking and analyzing user actions according to some implementations. In FIG. 1, the system 100 includes a movable device 202 and a mobile device 214.

The movable device 202 may be configured to transmit a function activation signal 205 to the mobile device 214, when an action is performed on the movable device 202. For example, the movable device 202 may be rotated or flipped over, from top 202-1 to bottom 202-2, similar to an hourglass, to transmit the activation signal.

The moveable device 202 may include an inertial measurement unit (IMU) 208. The IMU 208 may be configured to measure movement of the moveable device 202. The IMU 208 may generate a movement signal representative of such movement of the moveable device 202. Movement may include the force, linear and or angular movement of the moveable device 202. The IMU may include one or more accelerometers and/or gyroscopes to measure linear or angular movement of the moveable device 202.

The moveable device 202 may include a processor 206. The processor 206 may be configured to receive a movement signal from the IMU 208. If certain criteria are met, the processor 206 may transmit the activation signal 205 to the mobile device 214. A detailed description of such functionality is provided in more detail below.

The moveable device 202 may include a wireless transmitter 210 configured to wirelessly transmit the activation signal 205 to the mobile device 214 via a wireless communication standard (e.g., Bluetooth, Wifi, cell-specific).

The mobile device 214 may include a mobile application 204 and a user interface 106. The mobile application 204, when executed by a user, executes functions specific to the mobile application 204 at the mobile device 214, including receiving activation signals from the moveable device 202. In some embodiments, the mobile application 204 is a reading application that tracks, analyzes and displays data associated with reading one or more physical books or books on the mobile device 214. In some embodiments, the mobile application 204 may include a mobile timer 212 that initiates a timer in response to receiving a function activation signal 205 from the moveable device 202. In some embodiments, while the mobile timer 212 is activated and counting time, the mobile timer 212 may stop in response to receiving a subsequent activation signal 205 from the moveable device 202.

The mobile device 214 may include a user interface 207. In some implementations, the user interface 106 includes a display device capable of displaying data and a user input device for user input. The mobile device 214 may be any computer or other electronic device that is capable of communicating with the moveable device 202. Examples of mobile device 214 include, without limitation, mobile phones, smart phones, and personal digital assistants, laptops, notebooks. In some embodiments, the mobile device 214 may not be required to be mobile, and therefore include non-mobile personal computers, such as desktop computers.

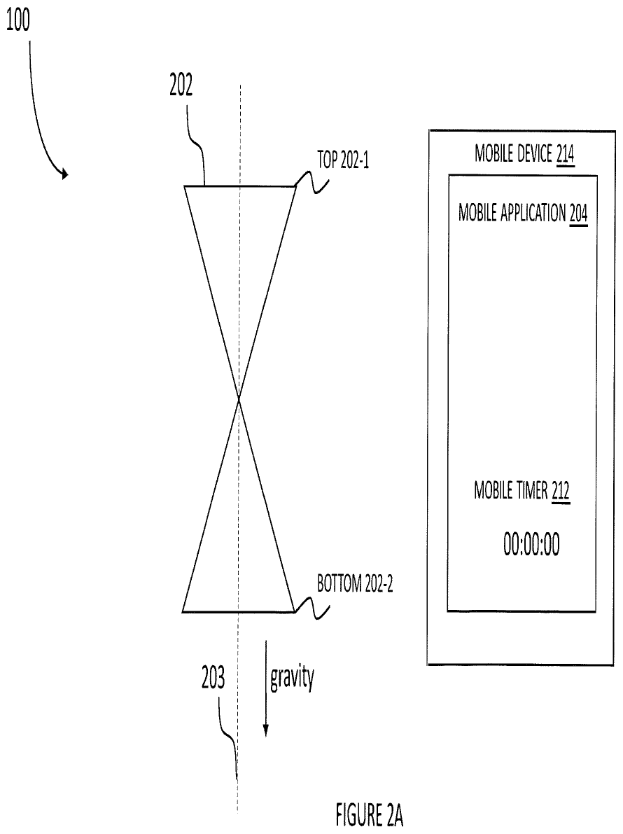

FIGS. 2A-2B illustrate activating a function of a mobile application 204 on a mobile device 214 using the moveable device 202.

Referring to FIG. 2A, the movable device 202 may be configured in an original configuration with a top end 202-1 and a bottom end 202-2. In some embodiments, movable device 202 may be shaped in an hourglass shape. In one embodiment, the movable device 202 may be translucent. Movable device 202 may be arranged along a y-axis 203 relative to gravity. In some embodiments, mobile application 204 may be configured to include a mobile timer 212. Initially, because the mobile timer 212 has not been activated, the mobile timer 212 is set to 00:00:00 (hrs:min:sec).

Referring to FIG. 2B, the user may flip the moveable device 202 to cause the moveable device 202 to send the activation signal 205 to the mobile application 214. In this example, the movement is a flip along an axis perpendicular to y-axis 203 (and gravity) such that the moveable device 202 is flipped from top end 202-1 to bottom end 202-2, as represented in FIG. 2B. The IMU 208 may detect the movement and generate a movement signal. The processor 206 may detect the movement signal at the IMU 208 indicating movement of the movable device 202. In response to detecting the movement signal from the wireless transmitter 210, the processor 206 may determine whether the movement signal meets movement criteria. The movement criteria may include a criterion that is met when the movable device 202 has rotated 180 degrees along an axis perpendicular to y-axis 203 and gravity. In one embodiment, when the movable device has rotated 180 degrees along an axis perpendicular to y-axis 203, bottom end 202-2 and top end 202-1 have alternated from their original position shown in FIG. 2A to new position shown in FIG. 2B. In response to determining that the movement signal meets movement criteria, the processor 206 may transmit a function activation signal 205 to the mobile device 214 to activate a function of the mobile application 204. In this example, the function of the mobile application is a mobile timer 212. A processor at the mobile device 214 may activate the mobile timer 212 in response to receiving the function activation signal 205. Activating the mobile timer 212 of the mobile application may include initiating the mobile timer 212 on the mobile application 204 to start. The mobile timer 212 may have various customizable options. For example, the mobile timer 212 may be an analog clock or a digital clock. In one embodiment, when the mobile timer 212 on the mobile application is activated the movable device 202 may appear to be “filling-up”.

In one embodiment, the user may desire to stop reading and as such stop mobile timer 212. To do so, the user may rotate the movable device 202 180 degrees perpendicular to y-axis 203 and gravity such that top end 202-1 and bottom end 202-2 are in the original position as shown in FIG. 2A. The IMU 208 may detect the movement and generate a movement signal. The processor 206 may detect the movement signal at the IMU 208 indicating movement of the movable device 202. In response to detecting the movement signal from the wireless transmitter 210, the processor 206 may determine whether the movement signal meets movement criteria. The movement criteria may include a criterion that is met when the movable device 202 has rotated 180 degrees along the y-axis 203, perpendicular to gravity. In one embodiment, when the movable device has completely rotated 180 degrees along y-axis 203, bottom end 202-2 and top end 202-1 have alternated from their original position shown in FIG. 2A to new position shown in FIG. 2B. In response to determining that the movement signal meets movement criteria, the processor 206 may transmit a function activation signal 205 to the mobile device 214 to activate a function of the mobile application 204. In this example, because the function is a timer 212, and the timer 212 is already running, receipt of the function activation signal 205 would cause a processor at mobile device 214 to stop the timer 212.

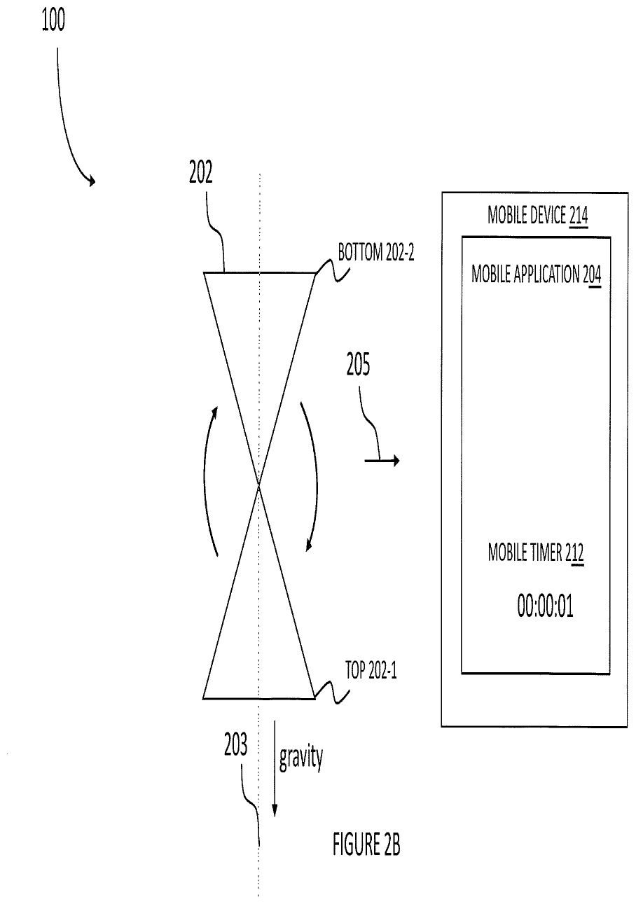

FIG. 3 is a flow diagram illustrating a method 300 for activating a function of a mobile application (e.g., mobile application 204) on a mobile device (e.g. mobile device 214), using a movable device (e.g. movable device 202). The movable device (e.g., movable device 202) may include a processor (e.g., processor 206), the processor may include an inertial measurement unit (e.g., IMU 208) and a wireless transmitter (e.g. wireless transmitter 210). While it is contemplated that other components may perform one or more steps described herein, for ease of explanation, the method 300 will be described as being performed by the components described in FIGS. 1, 2A, 2B, unless otherwise indicated.

In some embodiments, the processor 206 detects (302) a movement signal at the IMU 208 which may indicate movement of the movable device 202.

In some embodiments, in response to detecting the movement signal from the IMU 208, the processor 206 determines (304) whether the movement signal meets movement criteria.

In some embodiments, the movement criteria may include (305) a criterion that is met when the movable device (e.g. movable device 202) has rotated 180 degrees along an axis perpendicular to gravity (as represented by y-axis 203).

In some embodiments, in response to determining that the movement signal meets movement criteria, the processor 206 transmits (306) a function activation signal 205 to the mobile device 214 to activate the function of the mobile application 204.

In some embodiments, the function of the mobile application is (307) a timer 212.

In some embodiments, activating the function of the mobile application includes (308) initiating the timer on the mobile application 204.

In some embodiments, in response to determining that the movement signal does not meet movement criteria, refraining (309) from transmitting a function activation signal 205 to the mobile device to activate the function (e.g., timer) of the mobile application.

In at least one embodiment, there is included one or more computers having one or more processors and memory (e.g., one or more nonvolatile storage devices). In some embodiments, memory or computer readable storage medium of memory stores programs, modules and data structures, or a subset thereof for a processor to control and run the various systems and methods disclosed herein. In one embodiment, a non-transitory computer readable storage medium having stored thereon computer-executable instructions which, when executed by a processor, perform one or more of the methods disclosed herein.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention, different components as opposed to those specifically mentioned may perform at least some of the features described herein, and features of the disclosed embodiments may be combined. The words “right”, “left”, “lower” and “upper” designate directions in the drawings to which reference is made. The words “inwardly” and “outwardly” refer to directions toward and away from, respectively, the geometric center of the moveable device 202. As used herein, the terms “about” and “approximately” may refer to + or −10% of the value referenced. For example, “about 9” is understood to encompass 8.2 and 9.9.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

It will be understood that, although the terms “first,” “second,” etc. are sometimes used herein to describe various elements, these elements should not be limited by these terms. These terms are only used to distinguish one element from another. For example, a first element could be termed a second element, and, similarly, a second element could be termed a first element, without changing the meaning of the description, so long as all occurrences of the “first element” are renamed consistently and all occurrences of the second element are renamed consistently. The first element and the second element are both elements, but they are not the same element.

As used herein, the term “if” may be, optionally, construed to mean “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, operations, elements, and/or components, but do not preclude the presence or addition of one or more other features, integers, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

I/We claim:

1. A method for activating a function of a mobile application on a mobile device, using a movable device, the movable device including a processor, an inertial measurement unit and a wireless transmitter, the method comprising:
at a processor of the movable device:
detecting a movement signal of the movable device at the inertial measurement unit indicating movement of the movable device;
in response to detecting the movement signal, determining whether the movement signal meets movement criteria;
in response to determining that the movement signal meets movement criteria, transmitting a function activation signal to the mobile device to activate the function of the mobile application; and
in response to determining that the movement signal does not meet movement criteria, refraining from transmitting a function activation signal to the mobile device to activate the function of the mobile application.

2. The method of claim 1, wherein the movement criteria includes a criterion that is met when the movable device has rotated 180 degrees along an axis perpendicular to gravity.

3. The method of claim 1, wherein the function of the mobile application is a timer.

4. The method of claim 1, wherein activating the function of the mobile application includes initiating the timer on the mobile application.

5. The method of claim 1, further comprising:
at the mobile device:
in response to receiving the function activation signal, activating the function on the mobile application

6. A system for activating a function of a mobile application on a mobile device, the system comprising:
a movable device, the movable device including a processor, an inertial measurement unit and a wireless transmitter, the processor configured to perform the steps of:
detecting a movement signal from the inertial measurement unit indicating movement of the movable device;
in response to detecting the movement signal, determining whether the movement signal meets movement criteria;
in response to determining that the movement signal meets movement criteria, transmitting a function activation signal to the mobile device to activate the function of the mobile application; and
in response to determining that the movement signal does not meet movement criteria, refraining from transmitting a function activation signal to the mobile device to activate the function of the mobile application.

7. The system of claim 6, wherein the movement criteria includes a criterion that is met when the movable device has rotated 180 degrees along an axis perpendicular to gravity.

8. The system of claim 6, wherein the function of the mobile application is a timer.

9. The system of any of claim 6, wherein activating the function of the mobile application includes initiating the timer on the mobile application.

10. The system of claim 6, further comprising:
the mobile device configured to perform the steps of, in response to receiving the function activation signal, activating the function on the mobile application.
